(19) United States
(12) Patent Application Publication
(10) Pub. No.: US 2010/0258332 A1
(43) Pub. Date: Oct. 14, 2010

(54) INTERCHANGEABLE LIGHT SWITCH COVER SYSTEM

(76) Inventor: MAUREEN YARBOROUGH, Collierville, TN (US)

Correspondence Address: W. EDWARD RAMAGE, COMMERCE CENTER SUITE 1000, 211 COMMERCE ST, NASHVILLE, TN, 37201, US

(21) Appl. No.: 12/755,191

(22) Filed: Apr. 6, 2010

Related U.S. Application Data
(60) Provisional application No. 61/166,824, filed on Apr. 6, 2009.

(51) Int. Cl. H02G 3/14

(52) U.S. Cl. 174/66

(57) ABSTRACT

A system for interchangeable covers for light switches, power outlets, and other forms of electrical outlets or plugs. The present invention comprises a cover that fits over a standard light switch plate or similar electrical switch or outlet plate. The cover is removably attached to the light switch plate by means of one or more magnets, Velcro strips, adhesive strips, double-side tape, or similar attachment devices. A plurality of covers may be easily and quickly placed on and removed from the plate (or a plurality of plates), to suit the desires of the user. The covers can be of any design, including variations in color, shape, outline, and the like. The cover may be of any suitable configuration to match existing light fixtures, including single switch, double switch, switch plus dimmer slide, switch plus power outlet, and so on. Covers may be provided for power outlet plates, telephone jack plates, cable plug plates, combinations thereof, or similar plates used in households and businesses.

This application claims benefit of and priority to U.S. Provisional Application No. 61/166,824, filed Apr. 6, 2009, by Maureen Yarborough, and is entitled to that filing date for priority. The specification, figures and complete disclosure of U.S. Provisional Application No. 61/166,824 are incorporated herein by specific reference for all purposes.

### FIELD OF INVENTION

This invention relates to a system for interchangeable light switch covers. More particularly, this invention relates to a system for interchangeable covers for light switches, power outlets, and other forms of wall outlets or plugs.

### SUMMARY OF INVENTION

In various embodiments, the present invention comprises a system for interchangeable covers for light switches, power outlets, and other forms of wall outlets or plugs. In one embodiment, the present invention comprises a cover that fits over a standard light switch plate. The cover is removably attached to the light switch plate by means of one or more magnets, Velcro strips, adhesive strips, double-side tape, or similar attachment devices.

A plurality of covers may be easily and quickly placed on and removed from the plate (or a plurality of plates), to suit the desires of the user. The covers can be of any design, including variations in color, shape, outline, and the like. Covers may include logos of sports teams, school insignia, and a variety of other designs. The cover may be of any suitable configuration to match existing light fixtures, including single switch, double switch, switch plus dimmer slide, switch plus power outlet, and so on. In yet another embodiment, covers may be provided for power outlet plates, telephone jack plates, cable plug plates, combinations thereof, or similar plates used in households and businesses.

### DESCRIPTION OF THE DRAWINGS

FIG. 1 shows a top and bottom view of a light switch plate cover and light switch plate in accordance with one embodiment of the present invention.

### DETAILED DESCRIPTION OF EXEMPLARY EMBODIMENTS

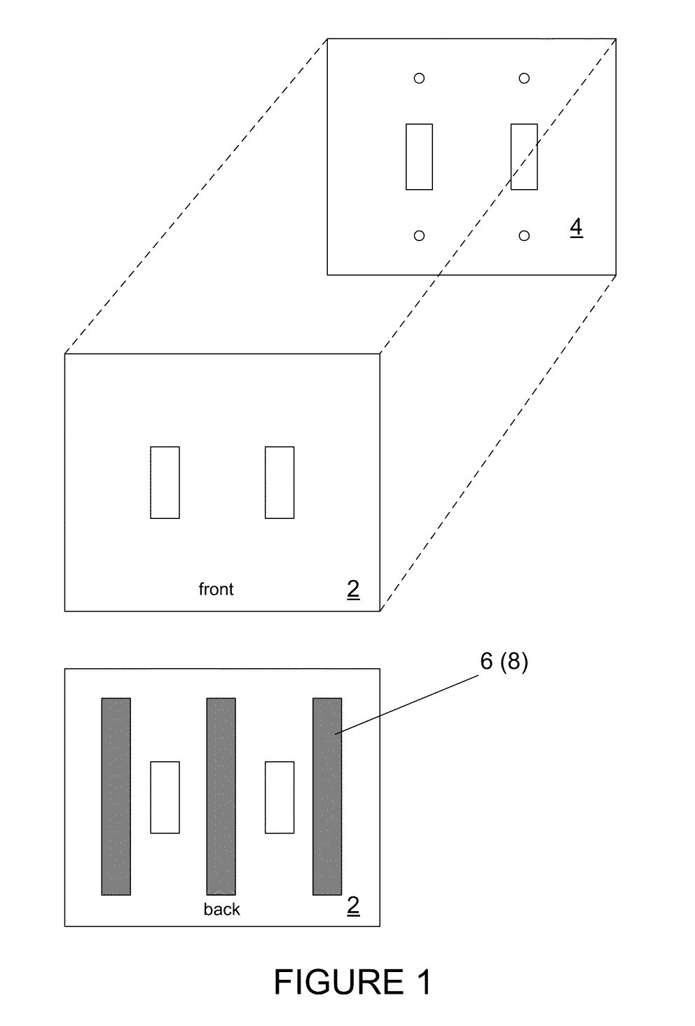

In one exemplary embodiment, the present invention comprises a system and apparatus for interchangeable covers for light switches, power outlets, and other forms of wall outlets or plugs. FIG. 1 shows an exemplary embodiment of the present invention comprising a cover 2 that fits over a standard light switch plate 4. The cover 2 does not replace the light switch plate; instead, it fits over it. The cover 2 is removably attached to the light switch plate 4 by means of one or more magnets 6, magnetic tape, Velcro strips, adhesive strips, double-side tape, or similar attachment devices.

In an embodiment where magnets 6 are used, one or more magnets may be located on the back of the cover, with corresponding magnets of appropriate polarity located on or affixed to the light switch plate 4. If the light switch plate 4 is made of a metal or similar material (as shown in FIG. 1), the matching magnets may be removably attached to the plate 4, or alternatively, the matching magnets may be foregone, and the cover 2 with magnets 6 may be removably attached directly to the plate 4. The magnets 6 on the cover 4 may be permanently affixed to the cover by means of glue, epoxy, adhesive, magnetic tape, a slot or holding clamps, or similar means. Alternatively, the magnets 8 may be removably attached to the cover 4, such as by means of a slot, grooves, clips, or holding clamp. Alternatively, the cover may be made of metal or similar material in whole or in part, with the magnets directly and removably affixed thereto.

Velcro strips attached to the back of the cover and the front of the plate can also be used to the same effect.

A plurality of covers 2 may thus be easily and quickly placed on and removed from the plate (or a plurality of plates), to suit the desires of the user. The covers can be of any design, including variations in color, shape, outline, and the like. Covers may include logos of sports teams, school insignia, and a variety of other designs. Said logos and designs may be painted, etched, or otherwise imprinted on the cover. Covers may be obtained or provided separately from the elements of the basic system.

The cover may be of any suitable configuration to match existing light fixtures, including single switch, double switch, switch plus dimmer slide, switch plus power outlet, and so on. In yet another embodiment, covers may be provided for power outlet plates, telephone jack plates, cable plug plates, combinations thereof, or similar plates used in households and businesses. The term “electrical switch or outlet plate” as used herein should be understood to refer to all of the above, and their equivalents.

Covers may be formed of any lightweight material, including but not limited to plastic, foam, wood, aluminum, aluminum alloy, or other metal. Thickness may vary, but thinner covers are preferred so as to allow the switch to protrude adequately, or to allow for adequate access to a plug, jack, or the like. In one exemplary embodiment, the cover comprises 0.020 inch thick aluminum.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A device, comprising:
a cover with a front side and a back side; and
attachment means to removably attach the back side of the cover to an electrical switch or outlet plate.

2. The device of claim 1, wherein the cover is configured with suitable openings to match corresponding openings in the electrical switch or outlet plate.

3. The device of claim 1, wherein the cover is slightly wider and longer that the electrical switch or outlet plate.

4. The device of claim 1, wherein the attachment means comprises one or more magnets or strips of magnetic tape affixed to the back of the cover.

5. The device of claim 1, wherein the magnets are permanently affixed to the back of the cover.

6. The device of claim 1, wherein the magnets are affixed by means of a slot or clip or holder on the back of the cover.

7. The device of claim 4, further comprising one or more magnets affixed to the electrical switch or outlet plate.

8. The device of claim 1, wherein the attachment means comprises Velcro strips.

9. The device of claim 1, wherein the electrical switch or outlet plate is a single switch light switch plate.

10. The device of claim 1, wherein the electrical switch or outlet plate is a multiple switch light switch plate.

11. The device of claim 1, wherein the electrical switch or outlet plate is a cable jack plate.

12. The device of claim 1, wherein the cover is quickly removed and replaced on the electrical switch or outlet plate.

13. The device of claim 1, wherein the cover contains a logo or design.

14. The device of claim 1, wherein the cover has a non-rectangular shape.
